(19) United States
(12) Patent Application Publication
(10) Pub. No.: US 2013/0303350 A1
(43) Pub. Date: Nov. 14, 2013

(54) MOLDING ROLLER, APPARATUS AND METHOD FOR MANUFACTURING SAME

(71) Applicant: CHIA-LING HSU, Tu-Cheng (TW)

(72) Inventor: CHIA-LING HSU, Tu-Cheng (TW)

(73) Assignee: HON HAI PRECISION INDUSTRY CO., LTD., Tu-Cheng (TW)

(21) Appl. No.: 13/593,472

(22) Filed: Aug. 23, 2012

(30) Foreign Application Priority Data
May 11, 2012 (TW) 101116992

(51) Int. Cl. B29C 41/34; B05C 9/12; B05D 3/12; B05D 5/00; B05D 3/00; F16C 13/00; B05C 13/02

(52) U.S. Cl. 492/30; 492/28; 118/66; 118/642; 427/271; 427/278

(57) ABSTRACT

A molding roller includes a main body and a seamless ring-shaped resin film. The main body has a smooth circumferential surface. The resin film is coated on the circumferential surface and has a molding surface opposite to the main body. The molding surface defines a number of molding patterns. The resin film is made of ethylene tetrafluoroethylene or poly tetrafluoroethylene.

### BACKGROUND

1. Technical Field

The present disclosure relates to a molding roller, an apparatus and a method for manufacturing the molding roller.

2. Description of Related Art

Optical films define a number of micro structures. One method for forming the micro structures is a roll forming process using a metal roller. The metal roller has a circumferential surface defining molding patterns coupled with the micro structures. The molding pattern is formed by a laser knife. However, the metal roller of the roll forming process has a relatively low forming efficiency, and has a relatively high cost.

Therefore, it is desirable to provide a molding roller, an apparatus and a method for making the molding roller that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a molding roller, according to a first exemplary embodiment.

FIG. 2 is a schematic view of an apparatus for manufacturing a molding roller, according to a second exemplary embodiment.

FIG. 3 and FIG. 4 are flowcharts of a method for manufacturing a molding roller, according to a third exemplary embodiment.

### DETAILED DESCRIPTION

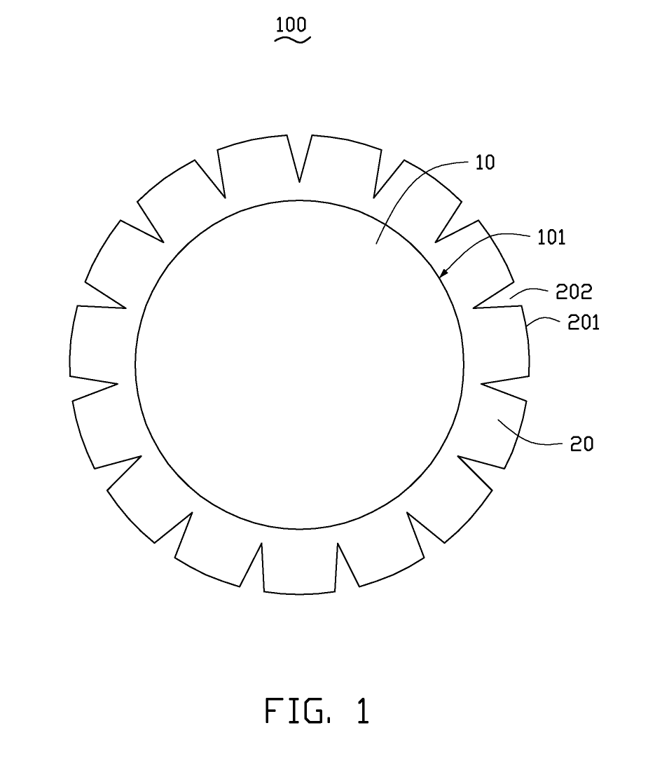

FIG. 1 illustrates a molding roller 100 in accordance to a first exemplary embodiment. The molding roller 100 includes a cylindrical main body 10 and a seamless resin film 20 directly coated on a smooth circumferential surface 101 of the main body 10.

The resin film 20 includes a molding surface 201 opposite to the main body 10. The molding surface 201 defines a number of molding patterns 202. In this embodiment, the molding patterns 202 are micro-grooves.

The main body 10 can be made of stainless steel or other metals. The resin film 20 is made of polymer resin having the molecular chain with fluorine element, such as ethylene tetrafluoroethylene (ETFE) or poly tetrafluoroethylene (PTFE), therefore optical films are easily separated from the resin film 20, and the quality of the optical films can be greatly improved.

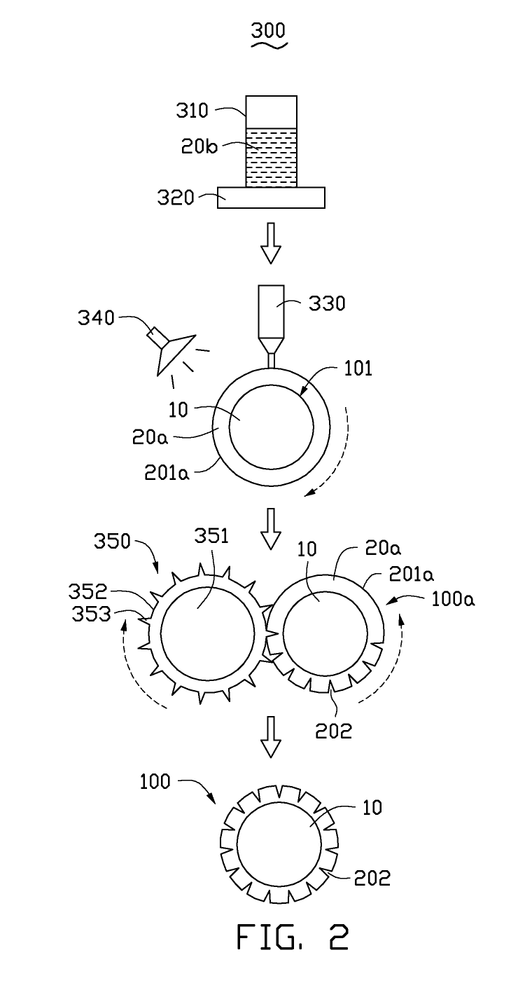

Referring to FIG. 2, an apparatus 300 for manufacturing the molding roller 100, according to a second exemplary embodiment, includes a container 310, a heating device 320, a coater 330, a drying device 340, and a processing device 350.

The container 310 is used for receiving a polymer resin 20b.

The heating device 320 is positioned under the container 310, and melts the polymer resin 20b at a predetermined temperature. In the second embodiment, the predetermined temperature is about 340 Celsius degrees.

The coater 330 rotates the main body 10 and evenly coats the melted polymer resin 20b on the circumferential surface 101.

The drying device 340 solidifies the melted polymer resin 20b to obtain a preprocessed molding film 20a. The preprocessed molding film 20a includes a preprocessed molding surface 201a opposite to the main body 10. The preprocessed film 20a and the main body 10 cooperatively form a preprocessed molding roller 100a. In the second embodiment, the drying device 340 is an ultraviolet source.

The processing device 350 is used for forming the molding patterns 202 on the preprocessed molding surface 201a. In the second embodiment, the processing device 350 includes a metal pressing roller 351. The pressing roller 351 has a rolling surface 352 spaced at a predetermined distance with the preprocessed molding roller 100a. The rolling surface 352 defines a number of impression patterns 353 coupled with the molding patterns 202, and is in contact with the preprocessed molding surface 201a. The pressing roller 351 and the preprocessed molding roller 100a are rotated in reverse directions to each other, and thus the molding patterns 202 are formed on the preprocessed molding surface 201a to obtain the molding roller 100.

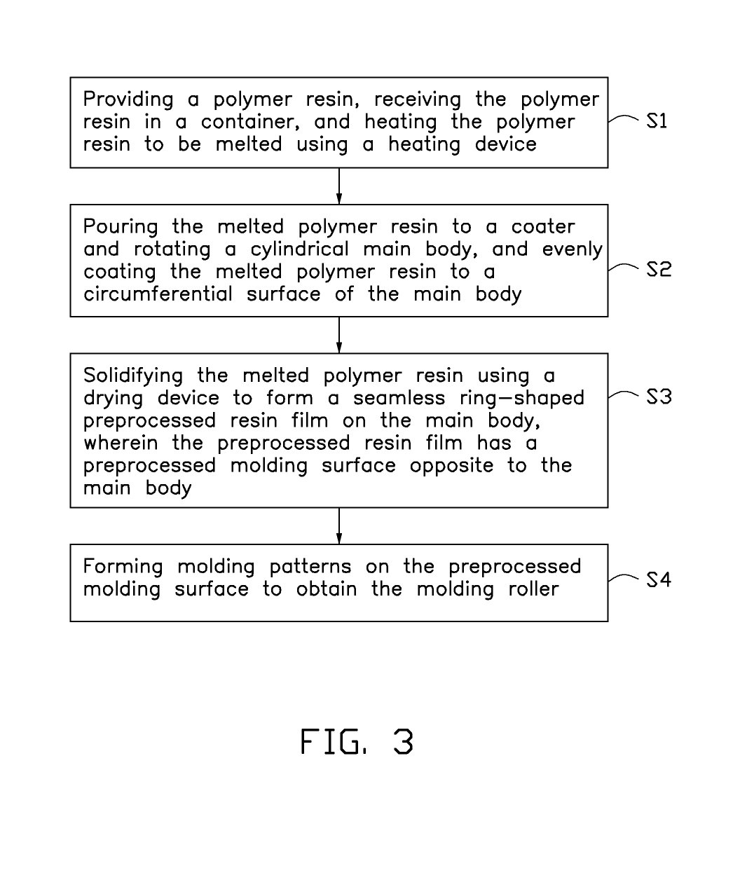

Referring to FIG. 3, a method for manufacturing the molding roller 100 using the apparatus 300, according to a third exemplary embodiment, includes the following steps.

In step S1, the container 310 and the heating device 320 are provided; the polymer resin 20b is received in the container 310, the heating device 32 melts the polymer resin 20b at a predetermined temperature. In the third embodiment, the predetermined temperature is about 340 Celsius degrees.

In step S2, the melted polymer resin 20b is poured into the coater 330, the coater 330 rotates the main body 10, and evenly distributes melted polymer resin 20b on the circumferential surface 101.

In step S3, the melted polymer resin 20b is solidified using the drying device 340 to form a seamless ring-shaped preprocessed resin film 20a. The preprocessed resin film 20a and the main body 10 cooperatively form the preprocessed molding roller 100a. The preprocessed molding roller 100a has a preprocessed molding surface 201a opposite to the main body 10.

In step S4, the impression patterns 202 are formed on the preprocessed molding surface 201a using the processing device 350. In the third embodiment, the processing device 350 is a pressing roller.

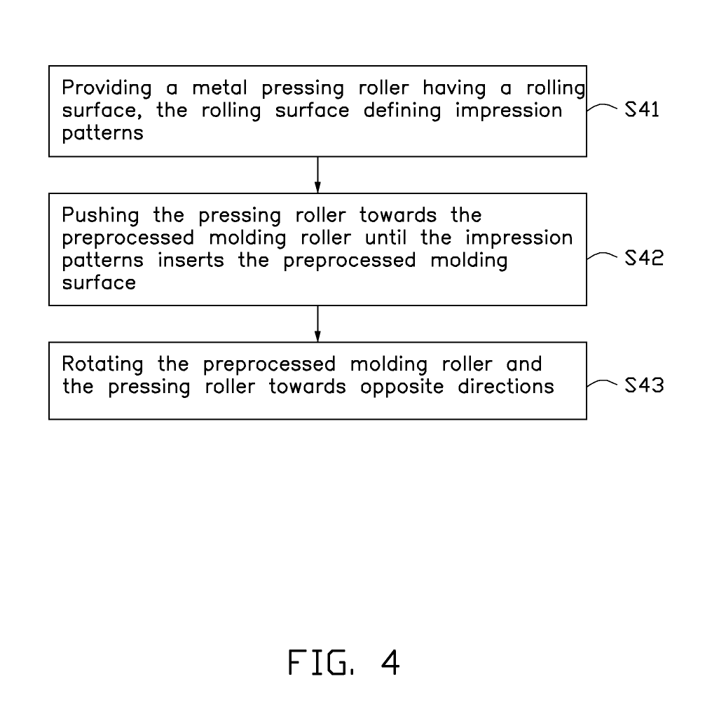

Referring to FIG. 4, the step S4 includes the following sub-steps.

In step S41, a pressing roller 351 is provided, and the pressing roller 351 has a rolling surface 352 defining the impression patterns 353.

In step S42, the pressing roller 351 is pushed towards the preprocessed molding surface 201a until the impression patterns 353 insert into the preprocessed molding surface 201a.

In step S43, the pressing roller 351 and the main body 10 are rotated in opposite directions, and thus the molding patterns 202 are formed on the preprocessed molding surface 353, and the molding roller 100 is thus obtained.

By employing the apparatus 300 and the method, the seamless resin film 20 can be directly coated on the main body 10, and the molding patterns 202 can be directly formed using the metal pressing roller 350, therefore, the manufacturing efficiency is improved.

The above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A molding roller, comprising:
a cylindrical main body having a smooth circumferential surface; and
a seamless ring-shaped resin film coated on the circumferential surface, the resin film having a molding surface opposite to the main body, the molding surface defining a plurality of molding patterns;
wherein the resin film is made of ethylene tetrafluoroethylene or poly tetrafluoroethylene.

2. The molding roller of claim 1, wherein the molding patterns are micro-grooves.

3. An apparatus for manufacturing a molding roller, comprises:
a container configured for receiving a polymer resin;
a heating device configured for heating the polymer resin to be melted;
a coater configured for rotating a cylindrical main body and evenly distributing the melted polymer resin on a circumferential surface of the main body;
a drying device configured for solidifying the melted polymer resin to form a seamless ring-shaped preprocessed resin film on the main body, and the preprocessed resin film having a preprocessed molding surface opposite to the main body; and
a processing device configured for forming molding patterns on the preprocessed molding surface to obtain the molding roller.

4. The apparatus of claim 3, wherein the drying device is an ultraviolet source.

5. The apparatus of claim 3, wherein the processing device comprises a metal pressing roller spaced at a predetermined distance with the preprocessed molding roller, the metal pressing roller has a rolling surface defining impression patterns mating with the molding patterns.

6. A method for manufacturing a molding roller, comprising:
providing a container containing a polymer resin therein;
heating the polymer resin to be melted using a heating device;
pouring the melted polymer resin to a coater;
rotating a cylindrical main body using the coater;
coating the melted polymer resin to a circumferential surface of the main body using the coater;
solidifying the melted polymer resin using a drying device to form a seamless ring-shaped preprocessed resin film on the main body, wherein the preprocessed resin film has a preprocessed molding surface opposite to the main body; and
forming molding patterns on the preprocessed molding surface to obtain the molding roller.

7. The method of claim 6, wherein the step of forming molding patterns on the preprocessed molding surface comprises:
providing a metal pressing roller having a rolling surface, the rolling surface defining impression patterns;
moving the pressing roller towards the preprocessed molding roller until the impression patterns insert the preprocessed molding surface; and
rotating the preprocessed molding roller and the pressing roller in opposite directions.

8. The method of claim 6, wherein the polymer resin is made of ethylene tetrafluoroethylene or poly tetrafluoroethylene.
